(19) United States
(12) Patent Application Publication
(10) Pub. No.: US 2024/0277169 A1
(43) Pub. Date: Aug. 22, 2024

(54) SPLIT SPOON WITH TONG FEATURE

(71) Applicants: Noble Pynadath Poulose, Burlington (CA); Jesmy Xavier Kannath, Burlington (CA)

(72) Inventors: Noble Pynadath Poulose, Burlington (CA); Jesmy Xavier Kannath, Burlington (CA)

(21) Appl. No.: 18/444,637

(22) Filed: Feb. 17, 2024

Related U.S. Application Data
(60) Provisional application No. 63/485,629, filed on Feb. 17, 2023.

(51) Int. Cl. A47G 21/10; A47J 43/28

(52) U.S. Cl. CPC A47G 21/10; A47J 43/283; A47J 43/288

(57) ABSTRACT

A utensil and method for transferring food, wherein the utensil comprises a bifurcated handle forming two operational halves and a split bowl design at its distal end, capable of articulating between an open and closed position to secure food. The utensil may include a tong-like mechanism for maintaining the closed position, with materials selected for environmental sustainability.

### CROSS-REFERENCE TO RELATED APPLICATIONS

This application claims priority to U.S. Provisional Application having Ser. No. 63/485,629, filed on Feb. 17, 2023, the entire disclosure of which is hereby incorporated herein by reference.

### BACKGROUND

### Background

The art of cutlery has evolved to encompass a variety of implements tailored for the preparation, serving, and consumption of food, yet it continually grapples with the limitations and capabilities of existing utensils. Standard designs, such as knives, forks, spoons and their derivations like sporks, integrating features of both spoons and forks, have seen innovations aimed at enhancing utility, user comfort, aesthetic appeal, and ergonomics. However, spoons, defined by their concave bowl ideal for scooping liquids or semi-liquids, have largely retained traditional design elements with minimal evolutionary change over the course of centuries. Manufacturing materials have varied, spanning stainless steel to various polymers, chosen to optimize for durability, cleaning convenience, aesthetics, and cost-efficiency.

Despite the pervasiveness of traditional spoon designs, their practical utility is hampered by shortcomings when used to serve certain foodstuffs, notably those of a soft or malleable consistency. The design and edge geometry of standard spoons are often insufficient for effectively containing such food items, resulting in frequent spillage and inconveniences, particularly when transferring smaller portions or when serving from containers with challenging geometries.

Tongs, comprised of dual arms joined at a fulcrum, excel in grasping larger or solid items, yet they falter when tasked with handling softer, more delicate foodstuffs. The common end design of tongs, featuring flat or serrated grips, fails to provide the necessary continuous surface area for securing small or pliable items, often leading to food deformation or breakage due to the exertion of uneven pressure.

Several attempts have been made to reconcile the functions of spoons and tongs, such as tongs with spoon-like ends. However, these designs frequently lack the necessary curvature to fully emulate spoon functionality, and the inherent clamping mechanism typical of tongs can be excessively forceful for soft food items, which negates their intended benefit.

Further considerations, drawn from ergonomic studies within cutlery design, place emphasis on ease of use, control, and stability during the act of transferring food items, advocating for designs that afford comfort to the user without imposing unnecessary physical exertion or strain. Traditional spoons and tongs often fail to meet these ergonomically advantageous criteria when dealing with certain food serving challenges.

An ongoing concern in cutlery manufacturing is the selection of materials in response to environmental considerations. The demand for durable yet ecologically considerate materials, such as those that offer recyclability or biodegradability, has become pronounced. With an expanded palette of materials at their disposal, designers and manufacturers have the opportunity to introduce innovative features in cutlery that align with modern sustainability goals while maintaining, or even enhancing, the functionality of such tools.

What is needed, therefore, is a serving utensil that amalgamates the dexterity and gentleness of a spoon with the gripping ability of tongs, doing so without comprising the integrity or presentation of the soft foods being served. Such a utensil would address the current technical challenges inherent to conventional spoons and tongs, and encapsulate material innovations and ergonomic design principles to enhance the serving experience. This innovation should not only satisfy contemporary culinary needs but also respect ergonomic standards and environmental considerations for sustainable usability.

### Field

### FIELD OF THE INVENTION

The present invention relates to the field of cutlery, specifically to an advanced utensil that combines the functions of a spoon and tongs to improve the user's ability to handle and serve a variety of food items with enhanced control, security, and efficiency.

### SUMMARY OF THE INVENTION

In one aspect, the present invention relates to a hybrid utensil that integrates the functional attributes of a traditional spoon with the mechanical capabilities of tongs. This utensil is characterized by its split bowl design which enables articulation between open and closed positions to facilitate the serving and transferring of various types of food with improved control and efficiency. The utility of this utensil is particularly apparent with respect to handling soft or malleable food items that are otherwise challenging to serve using conventional flatware without spillage or loss of the food.

One objective of the invention is to optimize the serving process by providing an ergonomic utensil that minimizes the risk of spillage. This is achieved through a unique bowl construction that allows for a secure closure, effectively cradling food items during transfer. A further objective is to enhance user convenience by offering a utensil that simplifies the serving of various food types, especially those that are delicate or prone to breaking apart when handled with traditional serving tools.

In an embodiment, the invention includes a bifurcated handle construction, with each half aligned with a corresponding bowl half to enable cohesive operation. The tong-like mechanism, which spans the length of the handle, further enables the user to transition between the open and closed bowl states with precision. This is accomplished through an operational locking element that engages or disengages the bowl halves, depending on the desired function, and maintains a secure grip on the food items until released.

Alternatively, to accommodate various user preferences and material design considerations, the invention contemplates a utensil devoid of a locking mechanism. In this construction, the bowl halves would be maintained in a closed configuration through manual pressure applied by the user's grip during operation. This promotes a design that relies on the inherent resilience of the materials and the user's dexterity, providing a simplified option for facilitating food transfer.

The versatility of the Split Spoon with Tong Feature is further demonstrated by its suitability for a diverse array of food types. Testing with items such as steak, salad, fish, chicken, and fruits has established the effectiveness of the utensil in securely transferring food with minimal spillage, validating its practical application and design relative to conventional flatware alternatives.

Lastly, an aspect of the invention contemplates a monolithic variant of the utensil, offering a single continuous piece construction. This version would employ flexible materials or different mechanical methodologies to achieve similar functional properties, while potentially sacrificing some stability in certain applications compared to the bifurcated embodiment.

Overall, the Split Spoon with Tong Feature offers a novel culinary instrument that provides significant improvements in food serving methods. Its ergonomic design, versatile construction options, and environmental sustainability considerations exemplify advancements in utensil design capable of delivering enhanced functionality, user convenience, and industry innovation.

### BRIEF DESCRIPTION OF THE DRAWINGS

FIG. 1 is a perspective view of a utensil with bifurcated handle halves (25a, 25b), each equipped with respective half handle grips (28a, 28b), and a split bowl design at the distal end (15a, 15b) connected via a pivot (20), all incorporating a locking mechanism (40) at the hinge (30).

FIG. 2 is a perspective view of a bifurcated utensil in an open position, showing a split spoon at the distal end, two operational halves of the handle, a pivot, a hinge, handle grips, and a locking mechanism inclusive of a locking tab.

FIG. 3 is a perspective view showing a utensil in an open position with a split bowl design at a distal end, comprising a first bowl half labeled “15a” and a second bowl half labeled “15b,” and a handle bifurcated along its length, which may include a tong-like mechanism and engagement features as described in claims of the present invention.

FIG. 4 is a perspective view of a utensil, illustrating the split spoon configuration in an open position with an engaged hook.

FIG. 5 is a top view of a utensil in a closed position, showing a handle (25) connected to a split spoon (10) comprising two bowl halves (15) that interlock to form a continuous surface, and a depiction of a locking element or engagement tab is absent in this view.

FIG. 6 is a front view of a bifurcated utensil in an open position, showing a split spoon configuration with two bowl halves, a pivot mechanism for articulation of the bowl halves, and locking features comprising a locking tab and a locking slot for securing the bowl halves in a closed position.

### DETAILED DESCRIPTION

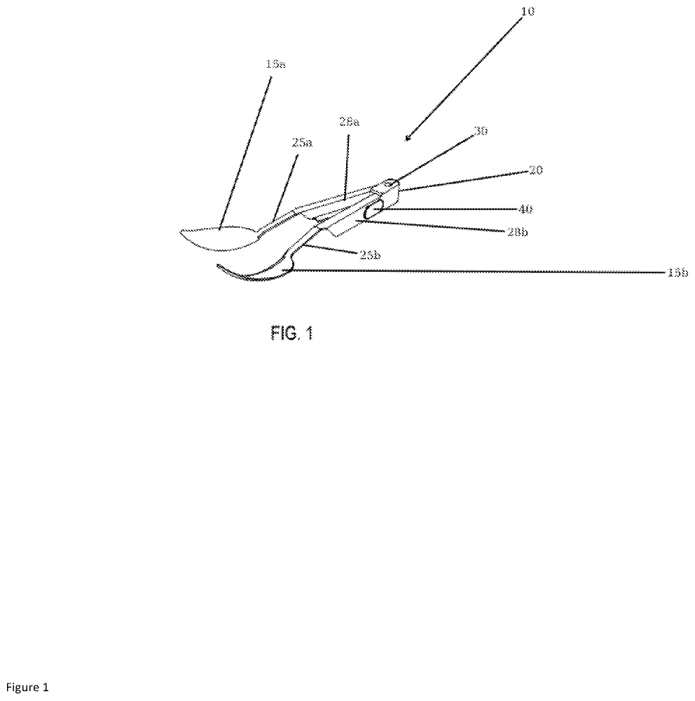

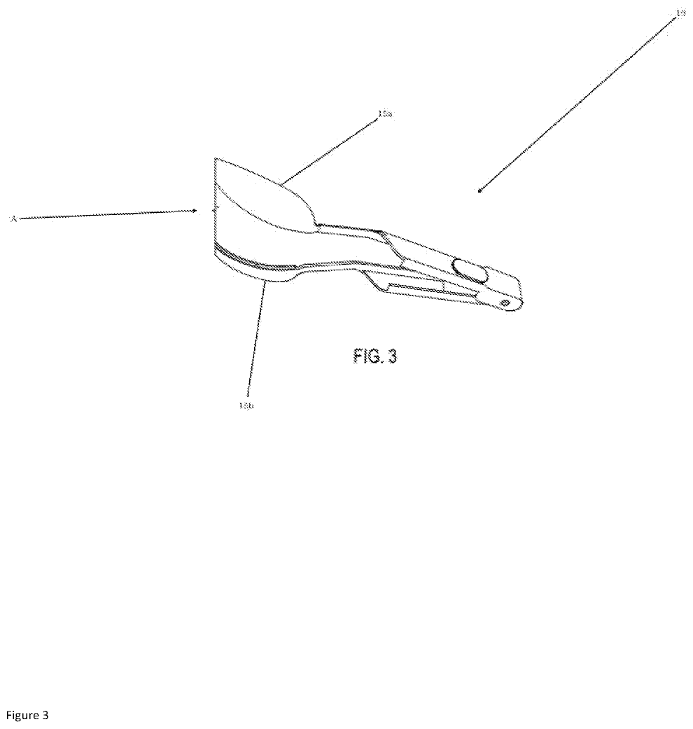

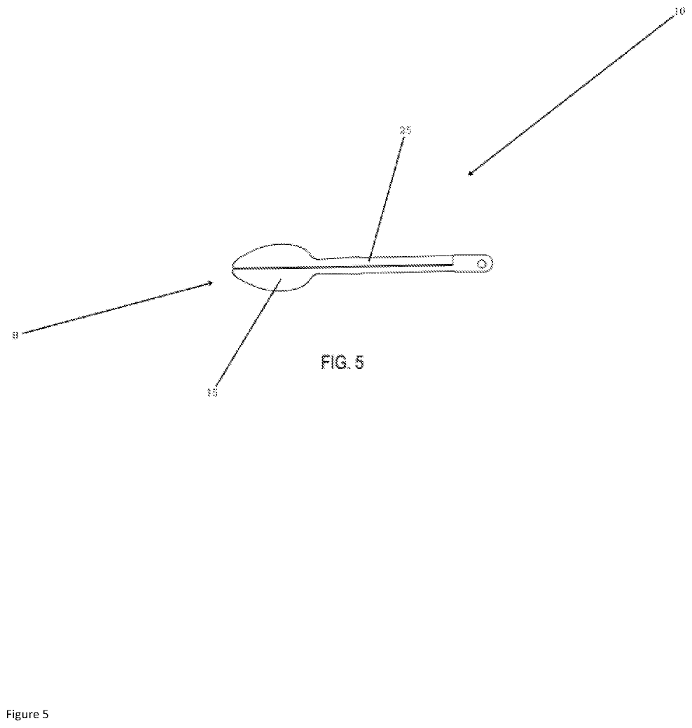

Turning to the figures, FIG. 1 shows a perspective view of an embodiment of a utensil, specifically illustrating a novel utensil that integrates the functionalities of a spoon and tongs. This embodiment features a handle divided along its length to form two operational halves, denoted as first handle half 25a and second handle half 25b, respectively. At the distal end of the handle, a split bowl configuration is presented, comprising a first bowl half 15a and a second bowl half 15b. The split bowl mechanism is designed to articulate between an open position A (as seen in FIG. 3), allowing for the insertion beneath a food item, and a closed position B (as seen in FIG. 5), securing the food item for transfer.

The articulation of the bowl halves is facilitated by a pivot 20 situated at the juncture where the bowl halves join. Furthermore, the utensil includes a tong-like mechanism characterized by a hinge 30 connecting the operational halves of the handle, and a locking mechanism 40 at the distal end of the handle, which is capable of maintaining the bowl halves in the closed position. Additionally, the utensil is equipped with grips, specifically a first half handle grip 28a and a second half handle grip 28b, to enhance the user's handling and control over the utensil.

The depicted utensil provides the structural and mechanical arrangement necessary to support the claims outlined in claims 1 through 5 and 7 through 11. The mechanical arrangement particularly enables the articulation of the bowl halves, their ability to interlock, and the operation of the tong-like mechanism with a locking element for retaining the bowl halves in their closed position. While the figure does not illustrate an external control, such as a slide button or the details of an engagement tab, it is understood that these components are incorporated within the tong-like mechanism encompassing the locking mechanism 40, as referenced in the description of the technology. The materials and processes for manufacturing such an utensil are suggested in the broader description to incorporate environmentally sustainable materials, which could include plastic, steel, or rubber with considerations for recyclability or biodegradability.

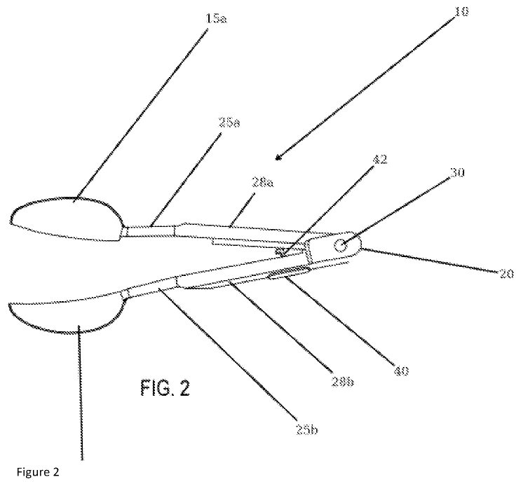

FIG. 2 shows a perspective view of a utensil incorporating a split spoon design, which comprises a handle bifurcated along its length to form two adjoining operational halves 25a, 25b, and a corresponding split bowl design at a distal end of the handle, with the first bowl half 15a and the second bowl half 15b. The bowl halves 15a, 15b are depicted in an articulated state and are capable of transitioning between an open position and a closed position. The two bowl halves 15a, 15b are designed to interlock to create a continuous surface for the purpose of securing food.

The utensil further includes a tong-like mechanism with a hinge 30 facilitating the articulation of the bowl halves 15a, 15b. The handle comprises two halves 25a, 25b with respective half handle grips 28a, 28b. A locking mechanism 40 is visible at the midpoint of the handle, which may serve to retain the bowl halves 15a, 15b in the closed position during use. The locking mechanism 40 incorporates a locking tab 42 which, as part of the mechanism, interacts with other components (Locking catch 45) not visible in this view to secure the bowl halves 15a, 15b. Additionally, a pivot 20 is depicted and serves as a key structural feature enabling the hinge 30 to function as intended.

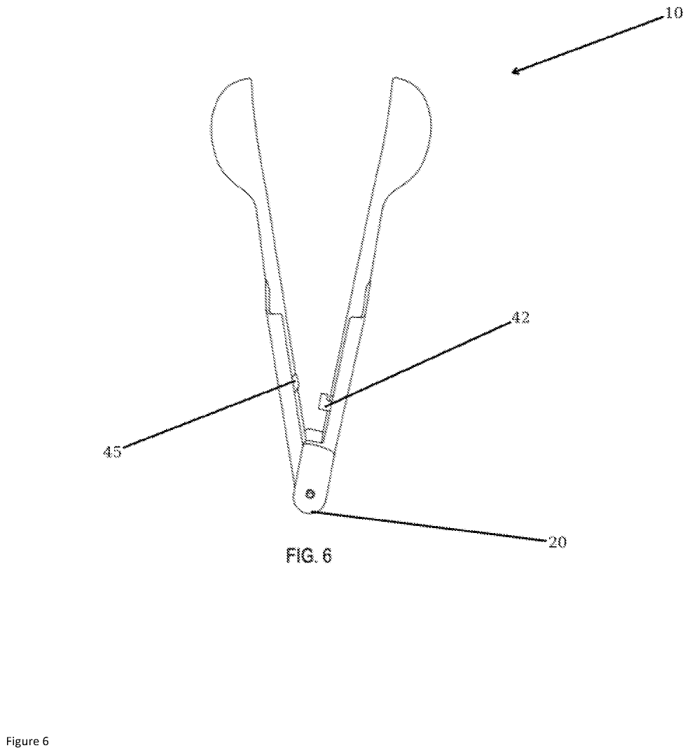

In one embodiment, as best seen in FIG. 6, the invention comprises a locking tab (42) and a locking catch (45). The locking tab (42) is configured to engage with the locking catch (45) in a manner that secures two components together. Locking tab 42 is vertically displaced by locking mechanism 40. The interaction between the locking tab (42) and the locking catch (45) ensures that the components remain attached until a predetermined force is applied to disengage the locking mechanism. The configuration of the locking tab (42) may include a protruding element designed to fit into a corresponding recess in the locking catch (45), thereby preventing accidental separation of the components. The locking catch (45), on the other hand, may include a flexible arm that allows for the insertion of the locking tab (42) and provides a retaining force to maintain engagement. This system is beneficial for applications requiring a reliable yet reversible means of component assembly.

The apparatus shown in FIG. 2 is consistent with a utensil that enables claims 1, 3, 4, 5, 11, 12, and 13 of the present specification. It depicts the structural features that allow the split spoon 10 to articulate between an open and closed state, clearly demonstrating the means by which the bowl halves 15a, 15b interlock to form a continuous surface. The placement of the hinge 30, locking mechanism 40, and locking tab 42 is shown in relation to the handle halves 25a, 25b with the half handle grips 28a, 28b, thereby elucidating the functional aspects of the utensil as they pertain to the claims.

FIG. 3 shows a perspective view of a split spoon 10 in an open position A, according to the present invention. The split spoon 10 is depicted with its first bowl half 15a and second bowl half 15b in an articulated state, such that the bowl halves are separated from one another, ready to be positioned under a food item in preparation for securing and transferring said item.

The figure illustrates the split spoon 10 with the first bowl half 15a and the second bowl half 15b, each representing the functional components of the spoon's bowl that are capable of transitioning between an open position A and a closed position B (as seen in FIG. 5). In the closed position B, these bowl halves interlock to form a bowl 15 having a continuous surface to enclose and secure food items during use. The articulation between the open position A and the closed position B enables the apparatus to function in a manner akin to tongs, facilitating the gripping and release of food items with enhanced control.

The alignment and the relative positioning of the first bowl half 15a and second bowl half 15b with respect to each other indicate the mechanism by which the split spoon 10 is transitioned between its open and closed states. This configuration supports the claims related to the utensil's design and function, particularly claims 1, 7, 6, and 11, as these claims involve the bowl halves' ability to articulate and interlock, the utensil's adaptation for receiving and securing food, the consideration of material properties for the utensil, and the method of transferring food using the described utensil.

Although not explicitly depicted in FIG. 3, this drawing enables the understanding and description of the tong-like mechanism that would span the handle, facilitating control of the split bowl configuration as described in the claims. This encompasses aspects related to the construction and operational function of the utensil, such as the use of a locking element and an external control, which may involve a slide button mechanism for securing the bowl halves in a closed position to effectively handle foods of various consistencies without spillage.

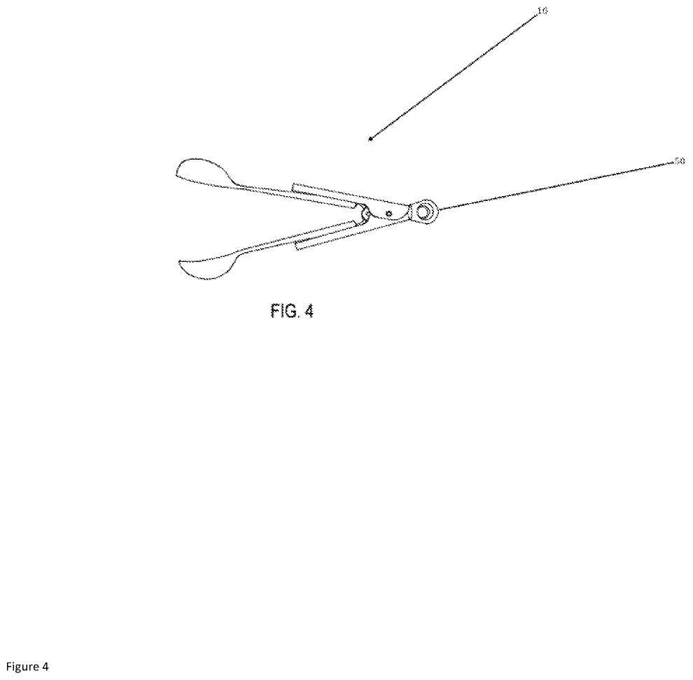

FIG. 4 shows a perspective view of an embodiment of the utensil with a split spoon 10 and a hook 50. The split spoon 10 at the distal end of the utensil comprises two halves that are designed to articulate between an open position and a closed position. When the spoon halves are brought together, they interlock to form a continuous surface, thereby enabling the utensil to secure food items with efficiency and reliability. Hook 50 is utilized for the purposes of hanging and storing the split spoon 10.

This embodiment is demonstrative of the broad inventive concept of a utensil integrating the dual functionality of a spoon and tongs, which can be applied in the method of securely transferring food. The depiction does not limit the construction of the utensil to any specific material, thereby enabling the use of various materials such as plastic, steel, or rubber, selected with environmental sustainability and considerations for recyclability or biodegradability.

FIG. 5 shows a utensil embodying a split spoon with tong feature, depicting the utensil in closed position B. The utensil includes handle 25 extending longitudinally and terminating at a distal end with split spoon 10. Split spoon 10 is shown in its interlocked form wherein two halves of the spoon have been brought together to create a continuous surface suitable for securing food. In this configuration, bowl 15 is in a state that mimics a traditional spoon's bowl, illustrating how the bowl halves align and interlock to function as a single entity for food retention.

The depicted utensil aligns with claim 1, comprising a handle 25 bifurcated along its length to form two adjoining operational halves that correspond to the halves of split spoon 10. Split spoon 10 is representative of the split bowl design at the distal end of handle 25. In the illustration, split spoon 10, while not visibly open, is capable of articulating between an open position and the closed position B as shown, enabling claims related to the articulating motion and the interlocking feature necessary for food security during transfer.

The design shown does not explicitly feature the tong-like mechanism spanning the bifurcated handle, nor a visible external control such as a slide button that enables such a mechanism; therefore, the depiction does not enable claims 3-5 and 12-13 which pertain to those elements. Nonetheless, the embodiment may incorporate such mechanisms not visible in the current perspective, which enables claim 1 and the method of claim 11, describing the operation of the utensil in a general sense without reference to a specific mechanism for maintaining the closed position.

Overall, FIG. 5 provides an exemplary embodiment of the inventive utensil, enabling claims 1 and 11 with respect to the interlocking feature of the split bowl design of the spoon and its operational capacity to transfer food effectively by articulating between an open and closed position.

FIG. 6 shows a utensil, specifically illustrating the interaction of certain components within the tong-like mechanism which is critical for the transition between open and closed positions of the split bowl design. The split spoon 10 is depicted in a partially open state, where the operational halves of the handle can be observed to be bifurcated, in alignment with the respective bowl halves.

Located within the geometry of the handle is the pivot 20. The pivot 20 serves as an axis of rotation for the operational handle halves, thereby enabling the articulation between the aforementioned open and closed states of the utensil. The pivot 20 is centrally positioned and acts as the fulcrum for the two adjoining operational halves of the handle to facilitate the utensil's functional movement.

The locking tab 42 is shown within the confines of the handle, designed to interact with a corresponding locking slot 45. The engagement of the locking tab 42 with the locking slot 45 acts as a retainer for the bowl halves, maintaining their position in the closed state B. This configuration provides a stable continuous surface for securing food item(s) once the split spoon 10 transitions from an open to a closed state.

The locking mechanism 40 is configured to selectively engage with and move the locking tab 42 in a vertical direction along the inside of second handle grip 28a. The locking mechanism 40 comprises an actuator, which is operatively connected to the locking tab 42. Upon activation of the actuator, the locking mechanism 40 exerts a force on the locking tab 42, causing it to move upwards or downwards along a predefined path defined by guide elements on the second handle grip 28a.

The guide elements are structured to control the movement of the locking tab 42, ensuring it moves in a linear fashion without rotation or lateral deviation. The actuator may be manually operated or powered by an external power source, depending on the embodiment of the locking mechanism 40. The engagement between the locking mechanism 40 and the locking tab 42 is such that when the actuator is not activated, the locking tab 42 remains stationary in its position, either in a locked or unlocked state relative to another component (not described herein).

Furthermore, the locking mechanism 40 may include a biasing element, such as a spring (not depicted), that biases the locking tab 42 towards one of its extreme positions, either the fully engaged (locked) or disengaged (unlocked) position. This biasing element ensures that the locking tab 42 remains in its designated position under normal conditions, preventing accidental displacement due to vibrations or other external forces.

In operation, the user manipulates the actuator of the locking mechanism 40 to overcome the force of the biasing element, allowing the locking tab 42 to move along the second handle grip 28a. Upon releasing the actuator, the biasing element may return the locking tab 42 to its original position, depending on the configuration of the locking mechanism 40 and the desired locking state.

Throughout the use of the utensil, the elements labeled in FIG. 6 work in concert to facilitate the operation of the split spoon 10. The pivot 20, locking tab 42, and locking slot 45 are integral to the structural integrity and functional effectiveness of the utensil, contributing to its capacity to provide precise control during the transfer of food items. This figure underpins claims that relate to the utensil's structural features which allow for the interlocking of the bowl halves and the retention of the utensil in a closed position when securing food.

The split spoon of the present invention may be used as a replacement or an alternative for the regular spoon that we eat with everyday. The split spoon will help lift the food from the plate seamlessly without any difficulty that you a user may face when using a regular spoon.

Although described herein as a split spoon, it is understood that the disclosure also encompasses a split spatula. This will be a viable alternative with better effectiveness on griddles, grills and teppanyaki tables where the current tools, including regular spatulas, fall short and often cause spillage and inconvenience.

It will be appreciated by those skilled in the art that while the split spoon with tong feature has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

1. A utensil comprising: a handle bifurcated along its length to form two adjoining operational handle halves; a split bowl design at a distal end of the handle having two bowl halves, each bowl half corresponding to one of the operational handle halves of the handle; and wherein the bowl halves are capable of articulating between an open position and a closed position thereby forming a continuous surface for securing food.

2. The utensil of claim 1, wherein the bowl halves are adapted to interlock upon closure to form a continuous surface for securing food.

3. The utensil of claim 1, further comprising a tong-like mechanism spanning the bifurcated handle, the tong-like mechanism including: a pivot, a hinge, a locking element having a locking tab and locking catch capable of retaining the bowl halves in the closed position; and wherein the locking tab is movable in response to the locking mechanism to engage the locking catch.

4. The utensil of claim 3, wherein the locking mechanism comprises a slide button located on an exterior of the tong-like mechanism.

5. The utensil of claim 4, wherein the locking element is positioned at a distal end or a midpoint of the handle.

6. The utensil of claim 1, wherein the materials selected for the utensil include at least one of:
plastic, steel, or rubber; and are characterized by environmental sustainability considerations.

7. A utensil comprising: a monolithic handle-integrated split bowl configuration, wherein the split bowl is adapted to transition between an open position for receiving food and a closed position for securing food; wherein the closed position is maintained based on inherent material resilience and manual pressure applied by a user.

8. The utensil of claim 7, wherein the material used for the monolithic handle-integrated split bowl configuration exhibits flexibility sufficient to allow the bowl to articulate between the open and closed positions.

9. The utensil of claim 7, wherein the materials selected for the utensil include at least one of: plastic, steel, or rubber; and are characterized by environmental sustainability considerations.

10. The utensil of claim 6, wherein the materials are selected based on recyclability or biodegradability properties.

11. A method of transferring food using a utensil, the method comprising: providing a utensil comprising a handle bifurcated along its length to form two adjoining operational halves, and a split bowl design at a distal end of the handle, wherein the split bowl design articulates between an open position and a closed position; sliding the bowl in the open position beneath a food item; and closing the split bowl to secure the food item before transferring.

12. The method of claim 11, further including the step of engaging a locking element via an external control to maintain the split bowl in the closed position during transfer.

13. The method of claim 12, wherein the external control comprises a slide button operated to activate an internal engagement tab that secures the locking element.
